(19) United States
(12) Patent Application Publication
(10) Pub. No.: US 2020/0122384 A1
(43) Pub. Date: Apr. 23, 2020

(54) STRETCHABLE MODIFIED POLYESTER FILM FOR IN-MOLD DECORATION FILM

(71) Applicant: NAN YA PLASTICS CORPORATION, TAIPEI (TW)

(72) Inventors: TE-CHAO LIAO, TAIPEI (TW); Wen-Cheng Yang, TAIPEI (TW); CHING-YAO YUAN, TAIPEI (TW); CHUN-CHENG YANG, TAIPEI (TW); Yu-Chi Hsieh, TAIPEI (TW)

(21) Appl. No.: 16/655,706

(22) Filed: Oct. 17, 2019

(30) Foreign Application Priority Data
Oct. 19, 2018 (TW) 107136854

(51) Int. Cl. B29C 55/08

(52) U.S. Cl. CPC B29C 55/08; B29K 2067/003

(57) ABSTRACT

A stretchable modified polyester film, and more particularly to a modified polyester film for in-mold decoration film and having high extensibility, high light transmittance, low shrinkage (high temperature resistance) and the like is provided. The stretchable polyester film is suitable to serve as a stretchable modified polyester film for an in-mold decoration film. The stretchable modified polyester film includes following components: (a) a polyester resin and (b) an acrylic resin.

### CROSS-REFERENCE TO RELATED PATENT APPLICATION

This application claims the benefit of priority to Taiwan Patent Application No. 107136854, filed on Oct. 19, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a stretchable modified polyester film, and more particularly to a modified polyester film for in-mold decoration film and having high extensibility, high light transmittance, low shrinkage (high temperature resistance) and the like.

### BACKGROUND OF THE DISCLOSURE

In-mold decoration (IMD) is a surface decoration technology commonly used worldwide for surface decoration and functional panels of home appliances, such as the surface decoration of mobile phone window lenses and outer cases.

More specifically, in-mold decoration technology is a technique in which a pattern or image is applied to a shaped article, and an integrated process of plastic processing such as film printing, compression molding, and injection molding. Compared with traditional surface technology, the advantage of in-mold decoration technology is that plastics produced by the in-mold decoration technology have beautiful appearances. The plastics produced by the in-mold decoration technology can have a variety of colors, patterns, and even tactile sensations, and be more wear-resistant and have higher brightness than plastics produced by paint-coating process. Therefore, the in-mold decoration technology having high production efficiency, high yield, high precision of stamping, and transferring more complicated patterns is suitable for large-scale production. The most important thing is that the in-mold decoration technology is non-polluting and can replace the traditional spraying and plating technology that causes environmental pollution.

As shown in FIG. 1, an in-mold decoration plastic film (in-mold decoration film) 10 has a five-layer structure, including a substrate 11, a printing ink layer 12, an adhesive layer 13, a release layer 14 and a hard coat 15. The substrate 11 in the in-mold decoration film 10 is selected from stretchable polyester films, such as a stretchable PET polyester film, and is required to have the characteristics of high light transmittance, high extensibility, breakage prevention, low shrinkage (high temperature resistance).

In the U.S. Patent Publication No. US2015299406 (A1), a biaxially stretched polyester film is disclosed, and a modified polyester film is added with 60% polybutylene phthalate. The modified polyester film is characterized by impact resistance and bendability, with an extensibility (MD/TD) up to 179% disclosed in the embodiments. For in-mold decoration technology, the extensibility of this modified polyester film is still insufficient. Further, the high draw ratio polyester film, as described in U.S. Pat. No. 9,375,902, has the characteristics of high extensibility, good molding and temperature resistance, and is suitable for forming polyester film for automobiles, construction, furniture. Although the extensibility of polyester film can be more than 300%, the polyester film structure is a three-layer or multi-layer structural composite film, and has disadvantages of complicated processing and high costs in order to achieve high extensibility.

### SUMMARY OF THE DISCLOSURE

In response to the above-referenced technical inadequacies, the present disclosure provides a single film stretchable polyester film which has excellent extensibility, heat resistance (low shrinkage), and high light transmittance, and can be used for high temperature and high pressure punching. The stretchable polyester film is suitable to serve as a stretchable modified polyester film for an in-mold decoration film. The stretchable modified polyester film includes following components:
(a) a polyester resin, which accounts for 10 to 99.99 parts by weight and is a polymer compound obtained by polycondensation of a dibasic acid and a diol or a derivative thereof, preferably a PET, PBT or PEN polyester resin; and
(b) an acrylic resin, which accounts for 0.01 to 60 parts by weight, and has an average molecular weight (Mw) between 10,000 and 80,000 according to ISO 1133 (230° C./3.8 kg), a melt index (MI) of the acrylic resin is between 1 ml and 40 ml per 10 minutes.

In one aspect, the present disclosure provides a stretchable modified polyester film suitable as a substrate of an in-mold decoration film and has the following characteristics so that the disadvantages that the substrate of the in-mold decoration film is not heat-resistant and has bad extensibility can be improved:

1. optical properties of the stretchable polyester film: light transmittance>88%

2. pull-down force test of the stretchable polyester film at 100° C.: draw ratio>150%

3. thermal stability of the stretchable polyester film: shrinkage rate<5% at 150° C. for 30 min.

4. formability of the stretchable polyester film: punchable high aspect ratio and high angle products have no film breakage.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a structural schematic view of an in-mold decoration film.

FIG. 2 is a punching die.

FIG. 3 is a graph showing a punching result of a stretchable polyester film of a present disclosure.

FIG. 4 is a graph showing a punching result of a general polyester film.

FIG. 5 is a graph showing analysis results of a dynamic mechanical analyzer (DMA) of the general polyester film (PET) and the stretchable polyester film (PET+acrylic resin) of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

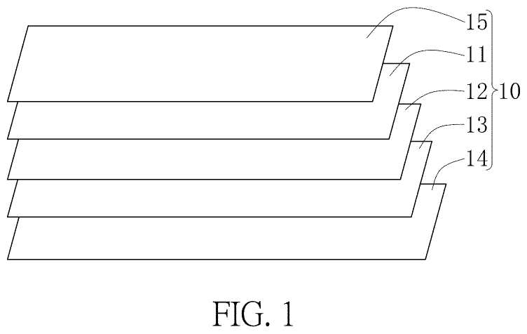

As shown in FIG. 1, a stretchable polyester film provided by the present disclosure is a modified polyester film having high extensibility, high transparency, and low shrinkage (high temperature resistance), and is suitable as a substrate 11 of an in-mold decoration film 10.

The stretchable polyester film of the present disclosure having excellent extensibility and heat shrinkability is suitable for high temperature and high pressure punching environment and includes following components:

(a) a polyester resin, which accounts for 10 to 99.99 parts by weight and is a polymer compound obtained by polycondensation of a dibasic acid and a diol or a derivative thereof, preferably a PET, PBT or PEN polyester resin; and

(b) an acrylic resin, which accounts for 0.01 to 60 parts by weight, and has an average molecular weight (Mw) between 10,000 and 80,000; according to ISO 1133 (230° C./3.8 kg) a melt index (MI) of the acrylic resin is between 1 ml and 40 ml per 10 minutes.

The polyester resin is a polymer compound obtained by polycondensation of a dibasic acid and a diol or a derivative thereof, or a polymer compound obtained by polycondensation of different kinds of dibasic acids or diols, and preferably selected from polycondensed PET, PBT or PEN polyester resins.

The dibasic acid is selected from one or any combination of terephthalic acid, isophthalic acid, 1,5-naphthalene dicarboxylic acid, 2,6-naphthalene dicarboxylic acid 2,6-naphthalene dicarboxylic acid, 1,4-naphthalene dicarboxylic acid, benzoic acid, diphenylethanedicarboxylic acid, diphenylphosphonium dicarboxylic acid, indole-2,6-dicarboxylic acid, 1,3-cyclopentanedicarboxylic acid, 1,3-cyclohexanedicarboxylic acid, 1,4-cyclohexanedicarboxylic acid, malonic acid, dimethylmalonic acid, succinic acid, diethyl 3,3-succinate, glutaric acid, 2,2-dimethylglutaric acid, adipic acid, 2-methyladipate, trimethyl adipate, pimelic acid, sebacic acid, sebacic acid, suberic acid and dodecanedioic acid.

The glycol is selected from one or any combination of ethylene glycol, propylene glycol, hexamethylene glycol, neopentyl glycol, 1,2-cyclohexanedimethanol, 1,4-cyclohexanedimethanol, 1,10-decanediol, 1,3-propanediol, 1,4-butanediol, 1,5-pentanediol, 1,6-hexanediol, 2,2-bis(4-hydroxyphenyl)propane and bis(4-hydroxyphenyl)anthracene.

The acrylic resin, which is obtained by polymerizing an acrylic monomer, and the acrylic monomer is selected from methyl (meth)acrylate (MMA), ethyl acrylate (EA), propyl (meth)acrylate (PA), n-butyl acrylate (BA), isobutyl (meth)acrylate (IBA), amyl methacrylate, hexyl (meth) acrylate, heptyl (meth) acrylate, octyl (meth) acrylate, 2-ethylhexyl (meth) acrylate (2-HEA), n-octyl (meth)acrylate (OA), isooctyl (meth) acrylate (IOA), decyl (meth) acrylate (NA), decyl (meth) acrylate, lauryl (meth) acrylate (LA), octadecyl (meth)acrylate, methoxyethyl (meth)acrylate (MOEA), n-butyl-methyl acrylate (n-BMA), 2-ethylhexyl acrylate (2-EHA) and ethoxymethyl (meth)acrylate (EOMAA), and may be used singly or in combination of two or more. The acrylic resin is mainly for adjusting the resin structure, provide appropriate glass transition temperature (Tg), and promote extensibility of acrylic resin with polyester resin and the rigidity of the film.

The average molecular weight (Mw) of the acrylic is between 10,000 and 80,000. When the average molecular weight of the acrylic resin exceeds the above range, the physical properties of the stretchable polyester film of the present disclosure are lowered.

According to ISO 1133 (230° C./3.8 kg) the melt index (MI), of the acrylic resin is between 1 ml and 40 ml per 10 minutes. When the melt index (MI) of polycarbonate is less than 1 g per 10 minutes, it is disadvantageous for processing into the stretchable polyester film of the present disclosure, and when the melt index (MI) exceeds 40 g per 10 minutes, the impact resistance of the stretchable polyester film of the present disclosure is lowered.

The acrylic resin is added to the polyester as a raw material during a process of mixing and extruding in a molten state. In an extension process after the polyester in a molten state is rolled into a modified polyester film, the added acrylic resin in an internal structure of the polyester film can promote the structure to become amorphous, so that an amorphous structure can increase draw ratio. Therefore, the stretchable polyester film obtained is highly amorphous, chemically resistant, water resistant and transparent.

More specifically, the stretchable polyester film of the present disclosure is a modified stretched polyester film obtained by drawing process. In the process, longitudinal uniaxial extension method, transverse uniaxial extension method, vertical axis successive biaxial extension method and the vertical axis simultaneous biaxial extension method may be adopted. According to different draw ratios, the transverse direction (TD) of an unstretched polyester film is subjected to 2.0 to 5.0 times of TD drawing process, preferably 2.5 to 4.0 times of TD drawing process, or further subjected to 2.0 to 5.0 times of MD extension process in the machine direction (MD), preferably 2.5 to 4.0 times of MD extension processing.

The stretchable polyester film of the present disclosure can improve degree of crystalline orientation of the stretchable polyester film along the extending direction after the above-mentioned extension process.

In order to satisfy in-mold decoration technology, the stretchable polyester film of the present disclosure should be subjected to a tensile test at a high temperature of 100° C. to simulate a vacuum high-temperature extrusion molding state in the in-mold decoration technology.

Aside from excellent dimensional stability, mechanical strength and transparency, the stretchable polyester film of the present disclosure has the following physical properties and characteristics:

1. optical properties of the stretchable polyester film: light transmittance>88%

2. pull-down force test of the stretchable polyester film at 100° C.: draw ratio>150%

3. thermal stability of the stretchable polyester film: shrinkage rate<5% at 150° C. for 30 min.

4. formability of the stretchable polyester film: punchable high aspect ratio and high angle products have no film breakage.

More specifically, the stretchable polyester film of the present disclosure is the modified stretched polyester film prepared by adding the acrylic resin to a polyester material, and has the characteristics of easy stretching, high extension rate, easy punching and no film breakage. Therefore, in hot-punching environment, the PET, PBT or PEN polyester film solves the problem of punching and film breakage due to the characteristics of high rigidity and insufficient extension rate, and even helps the punching effect to be better in high aspect ratio products.

Hereinafter, the present disclosure will be described more specifically by means of embodiments, but the present disclosure is not limited by the following embodiments. Physical property evaluation method in the embodiment is as follows:

1. Light Transmittance Test:

Optical transmittance values of the optical films of the following embodiments are tested using a haze meter TC-HIII from Tokyo Denshoku Co., Ltd. in accordance with JIS K7705. The higher the light transmittance is, the better the optical properties of the optical film are.

2. Tensile Test:

Tensile test is a common plastic mechanical testing method. A polyester film sample size is 25 cm*1.5 cm and is placed in a fixture of a tensile tester apparatus. The tensile tester then stresses the fixture and stretches at a constant speed (200 mm/min). According to the stress values required by the plastic shape variable until fracture, a stress-strain diagram is obtained.
1) Breaking strength (kgf/mm²): tensile stress of the plastic upon fracture.
2) Extension rate (%): extensional deformation of the plastic until fracture.

3. Dynamic Mechanical Analyzer (DMA):

A known amplitude and frequency of vibration is applied to the material sample at a programmed temperature and a function of the loss factor (Tan δ) and temperature, time, force and frequency is measured. The dynamic mechanical analyzer accurately determines the Young's modulus (E′), viscoelastic and other mechanical behaviors of the material, and by the obtained data, the strength, Tg point, seismic effect, material mixing effect, and various phase transition points of the stretchable polyester film with temperature changes can be known. This method is in accordance with ISO 6721-5, ISO 2856, ISO 4664, ASTM D-2231.

4. In-Mold Decoration (IMD) Punching Machine:

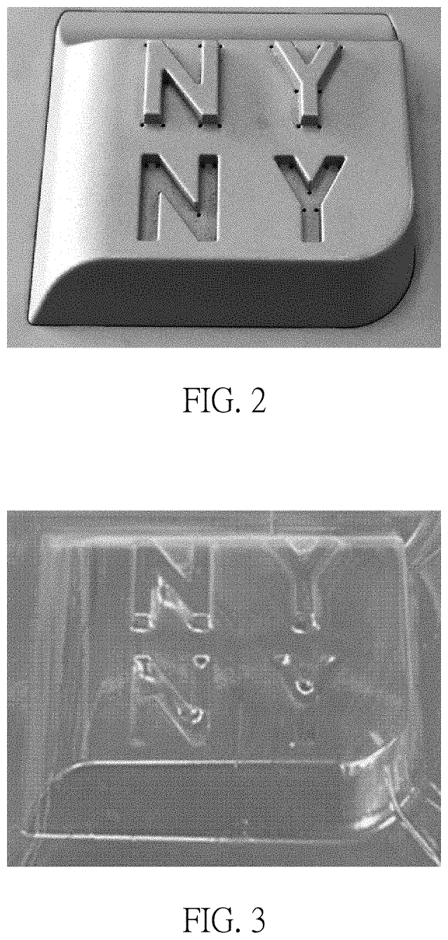

Hot punching test conditions are ladder type shape punching at 120° C. and 2 Kg/cm², a punching mold is shown in FIG. 2. In order to perform a hot punching test in which the stretchable film is attached to different substrates, the stretchable film is attached to an A-PET (non-amorphous PET) plate. A punching type is judged to be good or bad by observing whether the punched film/substrate and the punching material are closely adhered from the corners and depressions of the punching type, and the clarity of a punched type font so as to evaluate the punching result.

5. Heat Shrinkage Evaluation:

After the 15 cm*15 cm stretchable polyester film is placed in an oven at 150° C. for 30 minutes, a side length of the stretchable polyester film is measured, and the shrinkage length change is ΔX.

The shrinkage rate (in the MD direction) is ΔX/15 cm*100%.

### First Embodiment

According to the formulation of Table 1, 90 parts by weight of polyester pellets (PET) and 10 parts by weight of the acrylic resin are mixed and dispersed, dried at 120° C. for 12 hours, and then fed to an extruder at 280° C. for melting and extruding. A sheet is cooled and solidified by a cooling wheel having a surface temperature of 25° C. Thus, an unstretched PET sheet is obtained, and after heating, the machine direction (MD) extension is carried out at a draw ratio of 3.5 times. A completed uniaxially stretched PET film is then introduced into a 3.5 times transverse direction (TD) extension with a fixing clip, and then the biaxially stretched PET film is treated at 235° C. for 8 seconds to obtain a modified polyester film. Physical properties measurement results are shown in Table 1.

### Second Embodiment

According to the formulation of Table 1, 80 parts by weight of polyester pellets (PET) and 20 parts by weight of the acrylic resin are mixed and dispersed, dried at 120° C. for 12 hours, and then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3.5 times. A completed uniaxially stretched PET film is then introduced into a 3.5 times transverse direction extension (TD) with a fixing clip, and then the biaxially stretched PET film is treated at 235° C. for 8 seconds to obtain a modified polyester film. Physical properties measurement results are shown in Table 1.

### Third Embodiment

According to the formulation of Table 1, 70 parts by weight of polyester pellets (PET) and 30 parts by weight of the acrylic resin were mixed and dispersed, dried at 120° C. for 12 hours, then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3.5 times. A completed uniaxially stretched PET film is then introduced into a 3.5 times transverse direction extension (TD) with a fixing clip, and then the biaxially stretched PET film is treated at 235° C. for 8 seconds to obtain a modified polyester film. Physical properties measurement results are shown in Table 1.

### Fourth Embodiment

According to the formulation of Table 1, 60 parts by weight of polyester pellets (PET) and 40 parts by weight of the acrylic resin were mixed and dispersed, dried at 120° C. for 12 hours, then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3.5 times. A completed uniaxially stretched PET film is then introduced into a 3.5 times transverse direction extension (TD) with a fixing clip, and then the biaxially stretched PET film is treated at 235° C. for 8 seconds to obtain a modified polyester film. Physical properties measurement results are shown in Table 1.

### Fifth Embodiment

According to the formulation of Table 1, 50 parts by weight of polyester pellets (PET) and 50 parts by weight of the acrylic resin were mixed and dispersed, dried at 120° C. for 12 hours, then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3.5 times. A completed uniaxially stretched PET film is then introduced into a 3.5 times transverse direction extension (TD) with a fixing clip, and then the biaxially stretched PET film is treated at 235° C. for 8 seconds to obtain a modified polyester film. Physical properties measurement results are shown in Table 1.

### Sixth Embodiment

According to the formulation of Table 1, 60 parts by weight of polyester pellets (PET) and 40 parts by weight of the acrylic resin were mixed and dispersed, dried at 120° C. for 12 hours, then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3.5 times. A completed uniaxially stretched PET film is then introduced into a 3.5 times transverse direction extension (TD) with a fixing clip, and then the biaxially stretched PET film is treated at 235° C. for 8 seconds to obtain a modified polyester film. Physical properties measurement results are shown in Table 1.

### Seventh Embodiment

According to the formulation of Table 1, 90 parts by weight of polyester pellets (PET) and 10 parts by weight of the acrylic resin were mixed and dispersed, dried at 120° C. for 12 hours, then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3.5 times. A completed uniaxially stretched PET film is then introduced into a 3.5 times transverse direction extension (TD) with a fixing clip, and then the biaxially stretched PET film is treated at 235° C. for 8 seconds to obtain a modified polyester film. Physical properties measurement results are shown in Table 1.

### Eighth Embodiment

According to the formulation of Table 1, 80 parts by weight of polyester pellets (PET) and 20 parts by weight of the acrylic resin were mixed and dispersed, dried at 120° C. for 12 hours, then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3 times. A completed uniaxially stretched PET film is then introduced into a 3 times transverse direction extension (TD) with a fixing clip, and then the biaxially stretched PET film is treated at 235° C. for 8 seconds to obtain a modified polyester film. Physical properties measurement results are shown in Table 1.

### Ninth Embodiment

According to the formulation of Table 1, 70 parts by weight of polyester pellets (PET) and 30 parts by weight of the acrylic resin were mixed and dispersed, dried at 120° C. for 12 hours, then fed to an extruder at 280° C. for melting and extruding. A sheet is cooled and solidified by a cooling wheel having a surface temperature of 25° C. Thus, an unstretched PET sheet is obtained, and after heating, the machine direction extension (MD) is carried out at a draw ratio of 3 times. A completed uniaxially stretched PET film is then introduced into a 3 times transverse direction extension (TD) with a fixing clip, and then a biaxially stretched PET film is treated at 235° C. for 8 seconds to obtain a modified polyester film. Physical properties measurement results are shown in Table 1.

### Comparative Example 1

According to the formulation of Table 1, 100 parts by weight of polyester pellets (PET) and 0 parts by weight of the acrylic resin were mixed and dispersed, dried at 120° C. for 12 hours, then fed to an extruder at 280° C. for melting and extruding. A PET sheet is cooled and solidified by a cooling wheel having a surface temperature of 25° C. Thus, the unstretched PET sheet is obtained, and after heating, the machine direction extension (MD) is carried out at a draw ratio of 3.5 times. A completed uniaxially stretched PET film is then introduced into a 3.5 times transverse direction extension (TD) with a fixing clip, and then the biaxially stretched PET film is treated at 235° C. for 8 seconds to obtain a modified polyester film. Physical properties measurement results are shown in Table 1.

### Comparative Example 2

According to the formulation of Table 1, 80 parts by weight of polyester pellets (PET) and 20 parts by weight of the acrylic resin were mixed and dispersed, and dried at 120° C. for 12 hours, then fed to an extruder at 280° C. for melting and extruding. A PET sheet is cooled and solidified by a cooling wheel having a surface temperature of 25° C. Thus, the unstretched PET sheet is obtained, and after heating, the machine direction extension (MD) is carried out at a draw ratio of 2 times. A completed uniaxially stretched PET film is then introduced into a 2 times transverse direction extension (TD) with a fixing clip, and then the biaxially stretched PET film is treated at 235° C. for 8 seconds to obtain a modified polyester film. Physical properties measurement results are shown in Table 1.

### CONCLUSION

1. The modified extended PET polyester film obtained by Embodiments 1 to 9 are obtained by adding 10 to 60 parts by weight of acrylic resin raw material to the PET polyester resin, and after 3 to 3.5 times of uniaxial stretching in the machine direction (MD) or further 3 to 3.5 times in the transverse direction (TD), the crystallinity can be improved in the extending direction.

Further, the modified stretched PET polyester film obtained has characteristics such as excellent extensibility, heat resistance (low shrinkage), and high light transmittance after the crystallinity is improved. The products of the hot punching of the acrylic resin raw material are good, as shown in FIG. 3. The shape angle fits sharply and the shape bump is clearly a successful punch sample.

2. The modified extended PET polyester film obtained by Embodiments 7 to 9 are obtained by adding acrylic resin raw material to PET polyester resin. After 3 times of uniaxial stretching in the machine direction (MD) or 3 times of uniaxial stretching in the transverse direction (TD), the crystallinity can be increased in the extending direction. The modified stretched PET polyester film obtained has characteristics such as excellent extensibility and high light transmittance after the crystallinity is improved with a slight change in contractility merely.

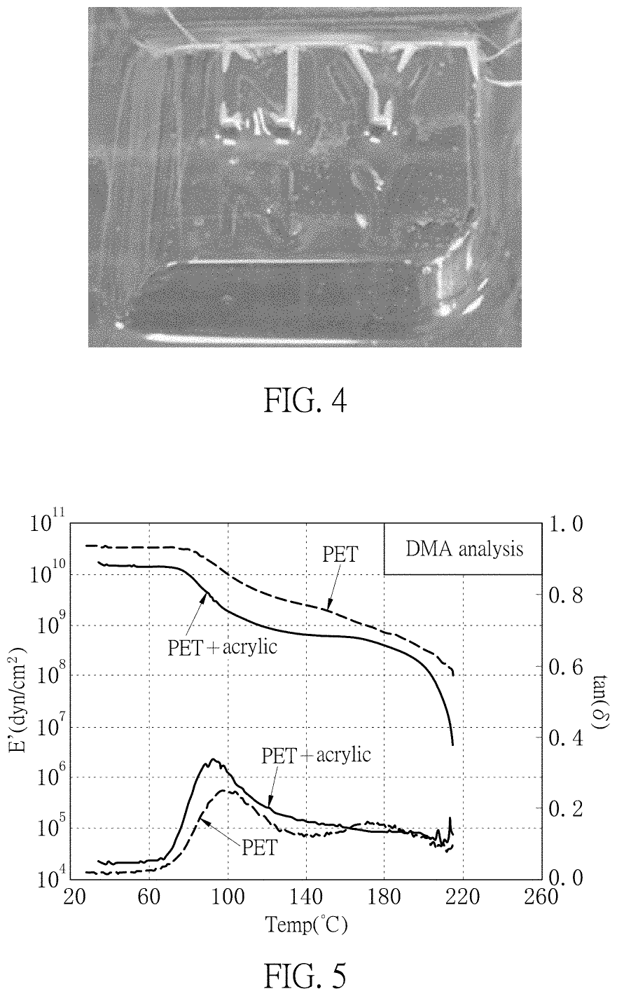

3. In Comparative Example 1, the biaxially stretched PET film is modified only by using a PET polyester resin as a raw material, excluding the addition of an acrylic resin for modification. As a result the obtained extended PET polyester film is excellent in light transmittance but poor in extensibility. The results of the hot punching of the acrylic resin raw material are bad. As shown in FIG. 4, the shape angle is large, and the shape unevenness is not obvious a failed sample. At the same time, comparing the results of the comparative examples 1 and 2, it can be seen from the DMA analysis in FIG. 5 that by introducing the acrylic resin to modify polyester film, stiffness (strength) of the film can be reduced, so that shape of the mold is more closely matched and the draw ratio is increased in the hot punching. Therefore, the modified polyester film into which an acrylic resin is introduced is suitable for the IMD.

4. The PET polyester film obtained in Comparative Example 2 is introduced with a 20 wt % acrylic resin without biaxial extension. As a result, the extended PET polyester film obtained has an extension effect of more than 300%, but the shrinkage is too large to be used in IMD technology.

TABLE 1
Protective film processing formula and physical properties

| | | | | | | | | | | | Comparative | |
|---|---|---|---|---|---|---|---|---|---|---|---|---|
| | | Embodiment | | | | | | | | | example | |
| Stretchable film | | 1 | 2 | 3 | 4 | 5 | 6 | 7 | 8 | 9 | 1 | 2 |
| Composition (%) | PET polyester | 90 | 80 | 70 | 60 | 50 | 40 | 90 | 80 | 70 | 100 | 80 |
| | Acrylic resin | 10 | 20 | 30 | 40 | 50 | 60 | 10 | 20 | 30 | 0 | 20 |
| Extended | MD extension | 3.5 | 3.5 | 3.5 | 3.5 | 3.5 | 3.5 | 3 | 3 | 3 | 3.5 | 1 |
| condition | TD extension | 3.5 | 3.5 | 3.5 | 3.5 | 3.5 | 3.5 | 3 | 3 | 3 | 3.5 | 1 |
| Physical property | Light | 90.1 | 89.7 | 89.8 | 89.4 | 89.2 | 89.2 | 90.0 | 89.8 | 89.1 | 90.1 | 89.9 |
| | transmittance | | | | | | | | | | | |
| | (%) | | | | | | | | | | | |
| | 100° C. | 200 | 350 | 300 | 280 | 250 | 180 | 220 | 370 | 320 | 120 | 330 |
| | Extensibility | | | | | | | | | | | |
| | (%) | | | | | | | | | | | |
| | 100° C. | 10.2 | 7.5 | 8.5 | 8.8 | 8.2 | 11 | 8.2 | 6.5 | 7.2 | 15.2 | 5.6 |
| | Breaking | | | | | | | | | | | |
| | strength | | | | | | | | | | | |
| | (Kg/mm²) | | | | | | | | | | | |
| | Shrinkage rate | 1.2 | 1.3 | 1.2 | 1.3 | 1.5 | 1.4 | 2.1 | 2.3 | 2.4 | 0.8 | 7 |
| | (%) | | | | | | | | | | | |
| | Punching | OK | OK | OK | OK | OK | OK | OK | OK | OK | NG | NG |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stretchable modified polyester film for an in-mold decoration film processed by extending 2.0 to 5.0 times along a transverse direction (TD) and 2.0 to 5.0 times along a machine direction (MD), comprising:
(a) a polyester resin, which accounts for 10 to 99.99 parts by weight and is a polymer compound obtained by polycondensation of a dibasic acid and a diol or a derivative thereof; and
(b) an acrylic resin, which accounts for 0.01 to 60 parts by weight, and has the average molecular weight (Mw) between 10,000 and 80,000;
wherein the physical properties of the stretchable modified polyester film satisfies the following conditions: light transmittance>88%; draw ratio>150%; shrinkage rate<5% at 150° C. for 30 min.

2. The stretchable modified polyester film according to claim 1, wherein the polyester resin is selected from PET, PBT or PEN polyester resins.

3. The stretchable modified polyester film according to claim 1, wherein the acrylic resin is obtained by polymerizing an acrylic monomer, and is selected from methyl (meth)acrylate (MMA), ethyl acrylate (EA), propyl (meth)acrylate (PA), n-butyl acrylate (BA), isobutyl (meth)acrylate (IBA), amyl methacrylate, hexyl (meth) acrylate, heptyl (meth) acrylate, octyl (meth) acrylate, 2-ethylhexyl (meth) acrylate (2-HEA), n-octyl (meth)acrylate (OA), isooctyl (meth) acrylate (IOA), decyl (meth) acrylate (NA), decyl (meth) acrylate, lauryl (meth) acrylate (LA), octadecyl (meth)acrylate, methoxyethyl (meth)acrylate (MOEA), n-butyl-methyl acrylate (n-BMA), 2-ethylhexyl acrylate (2-EHA) and ethoxymethyl (meth)acrylate (EOMAA), and may be used singly or in combination of two or more.

4. The stretchable modified polyester film according to claim 3, wherein according to ISO 1133 (230° C./3.8 kg), a melt index (MI) of the acrylic resin is between 1 ml and 40 ml per 10 minutes.
